(19) United States
(12) Patent Application Publication
(10) Pub. No.: US 2003/0232103 A1
(43) Pub. Date: Dec. 18, 2003

(54) Tortilla pressing apparatus and method

(75) Inventors: Robert M. Marino, Fayetteville, AR (US); Raymond C. Maday, Fayetteville, AR (US); John M. Silvester, Upper Mount Gravatt (AU); Adam G. Dargusch, Everton Park (AU)

Correspondence Address: FELLERS SNIDER BLANKENSHIP, BAILEY & TIPPENS, THE KENNEDY BUILDING, 321 SOUTH BOSTON SUITE 800, TULSA, OK, 74103-3318, US

(73) Assignee: Tyson Foods, Inc.

(21) Appl. No.: 10/392,378

(22) Filed: Mar. 19, 2003

Related U.S. Application Data
(60) Provisional application No. 60/365,409, filed on Mar. 19, 2002.

(51) Int. Cl. B29C 43/06

(52) U.S. Cl. 425/371; 425/308; 425/406

(57) ABSTRACT

A method and apparatus for pressing tortilla dough into a tortilla product in a continuous operation including: an extruder for compressing tortilla dough through a nozzle; a knife for slicing the extruded dough into a series of dough pucks; a conveyor press assembly which sandwiches the dough puck between a pair of belts to carry the puck between a pairs of platens to gradually press the puck into its final tortilla form; and a conveyor oven which sandwiches the tortilla between a pair of belts to carry the tortilla between pairs of heated platens to cook the tortilla. The system is particularly well suited to automation and, in one embodiment, includes measuring equipment which provides feedback to produce tortillas of consistent size, shape, and quality.

### CROSS REFERENCE TO RELATED APPLICATION

This application claims priority from copending U.S. provisional patent application Serial No. 60/365,409, filed Mar. 19, 2002, the disclosure of which is incorporated herein by reference.

### BACKGROUND OF THE INVENTION

1. Field of the Invention

This invention relates generally to methods and apparatuses for extruding, cutting, and automatically pressing tortilla dough.

2. Background

Flour tortillas are typically produced in a series of steps which involves: mixing the ingredients into dough; extruding and cutting the dough to form dough pucks, pressing each dough puck into a round, flat tortilla, and cooking the tortilla.

Current systems for pressing flour tortillas typically utilize heavy platen presses and require at least three distinct indexing steps. In the first step, the product dough is indexed into the press assembly. In the second step, the assembly indexes the dough to a press position wherein the heavy platens move toward the dough to press the dough into its final shape. In the third step, the pressed product is indexed to a product removal position. The requirement that such prior art devices be operated in a sequence of distinct indexing steps significantly limits the available speed and production capacity of the prior art system.

### SUMMARY OF THE INVENTION

The present invention satisfies the needs and alleviates the problems and shortcomings indicated above. In one aspect, the present invention provides a method and apparatus for extruding ant cutting tortilla dough to provide dough pucks of controlled size, weight, shape, and quality. In contrast to previous extruding systems and methods, the inventive system and method does not significantly “work” (i.e., impart energy into) the dough during the extrusion process. Thus, there is no need for a proofing and resting step following extrusion to allow the gluten structures of the dough to reform.

The inventive extruding apparatus also includes interchangeable nozzles which allow the operator to quickly and conveniently change the diameter of the product. The inventive extrusion apparatus is also computer controlled to allow the operator to essentially dial in any product weight and speed desired. In contrast, the extrusion devices used heretofore are typically labor intensive and require highly skilled operators who are capable of selecting and exchanging the appropriate system components and of making the appropriate fine tuning adjustments to obtain the product weights, size, and speeds desired.

In another aspect, the present invention provides an apparatus and method for pressing the tortilla dough in a continuous manner without requiring a series of discrete indexing steps. The inventive press thus provides much higher production speeds than the existing technology. The inventive press is highly adaptable to and can quickly be adjusted for variations in dough rheology.

In yet another aspect, the present invention provides a combined apparatus and method for extruding and pressing tortilla dough. In this system, the inventive extruder is preferably coupled and fully integrated with the inventive press to provide quick, automated synchronization of the extrusion and pressing operations. The inventive integrated system produces high quality round tortilla products at speeds of 4 times, or more, that of existing systems.

In still another aspect, the present invention provides a combined apparatus and method for extruding, pressing, and cooking tortilla dough. In this system, the inventive extruder is coupled to and fully integrated with the inventive press, which is further coupled to and integrated with an oven to provide synchronization of the extrusion, pressing, and cooking operations.

Further objects, features and advantages of the present invention will be apparent to those skilled in the art upon examining the accompanying drawings and upon reading the following detailed description of the preferred embodiments.

### BRIEF DESCRIPTION OF THE DRAWINGS

FIG. 1 provides a flow diagram describing the steps and processes of the inventive method for making a tortilla product.

FIG. 2 provides a perspective view of a preferred extruder used in conjunction with the present invention showing the output end of the extruder.

FIG. 3 provides a perspective view of the extruder of FIG. 2 as viewed from the motor end of the extruder.

FIGS. 4A-4C provide a perspective view of preferred embodiments of the combined extruder, press, and oven.

FIGS. 5A-5B provide a perspective view of the inventive tortilla press.

FIG. 6 depicts a pressure plate assembly particularly preferred for use in the inventive pressing system.

FIG. 7 depicts a heated pressure plate assembly particularly preferred for use in the inventive pressing apparatus.

### DETAILED DESCRIPTION OF THE PREFERRED EMBODIMENT

Before explaining the present invention in detail, it is important to understand that the invention is not limited in its application to the details of the construction illustrated and the steps described herein. The invention is capable of other embodiments and of being practiced or carried out in a variety of ways. It is to be understood that the phraseology and terminology employed herein is for the purpose of description and not of limitation.

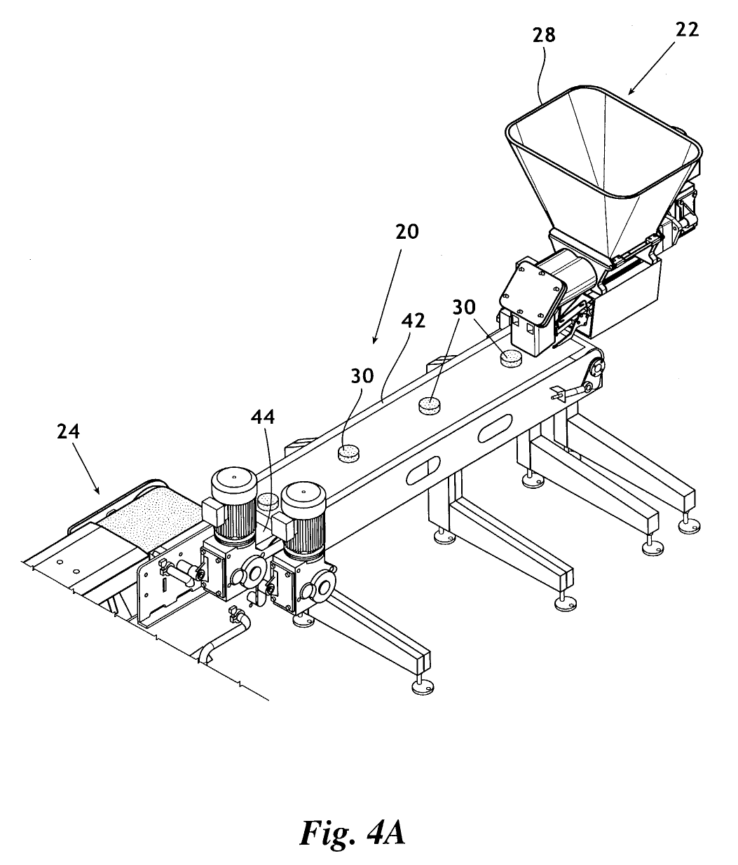

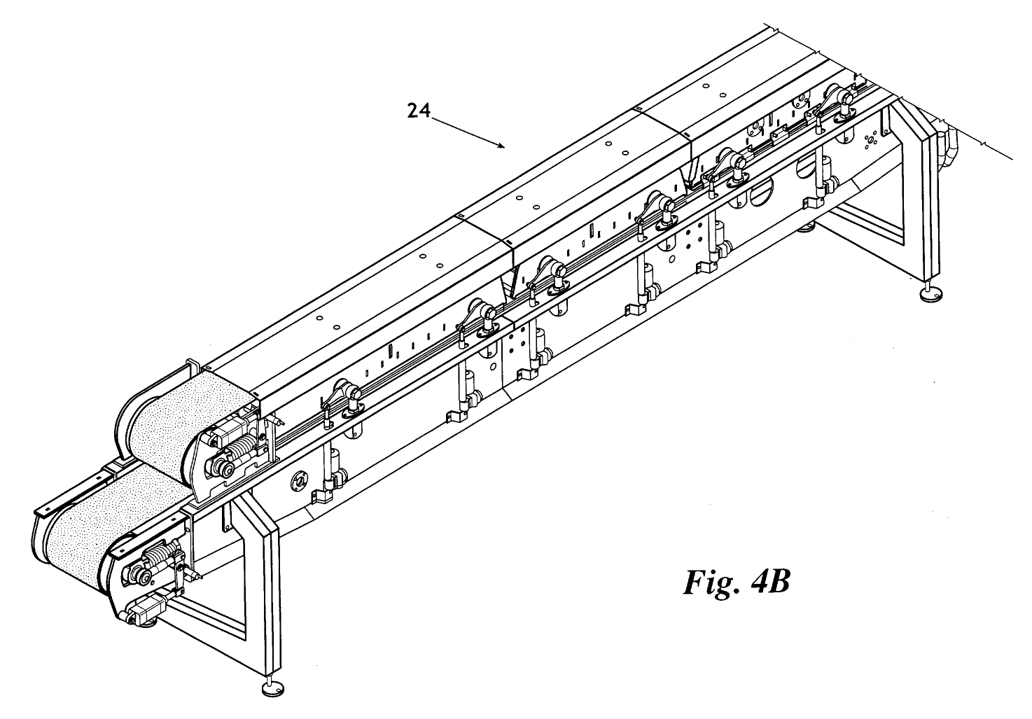

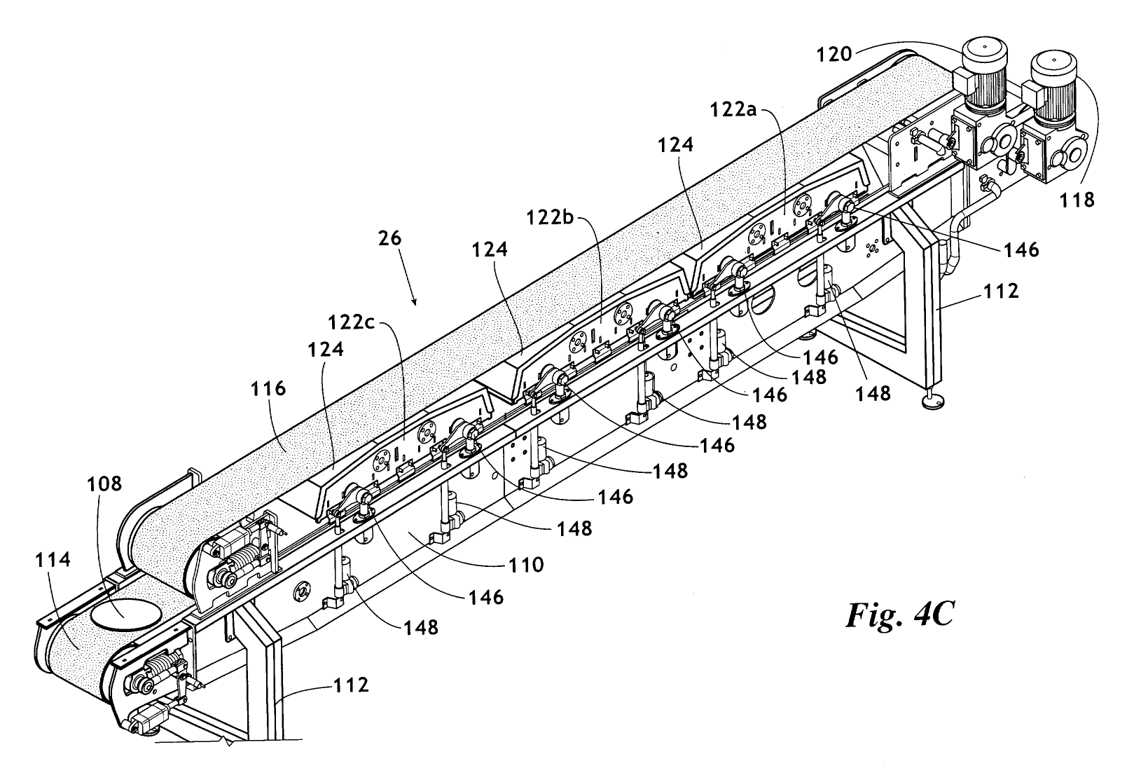

Referring now to the drawings, wherein like reference numerals indicate the same parts throughout the several views, a preferred embodiment of the inventive tortilla press 20 is shown in FIGS. 4A-4C. Preferably tortilla press 20 comprises three major assemblies: extruder 22; press assembly 24; and oven assembly 26. In the preferred embodiment, tortilla dough is fed into the system 20 through hopper 28 and, in a continuous process, extruded and sliced into dough pucks 30 by extruder 22. In turn, dough pucks 30 are pressed into flat tortillas by press 24, and cooked in oven 26.

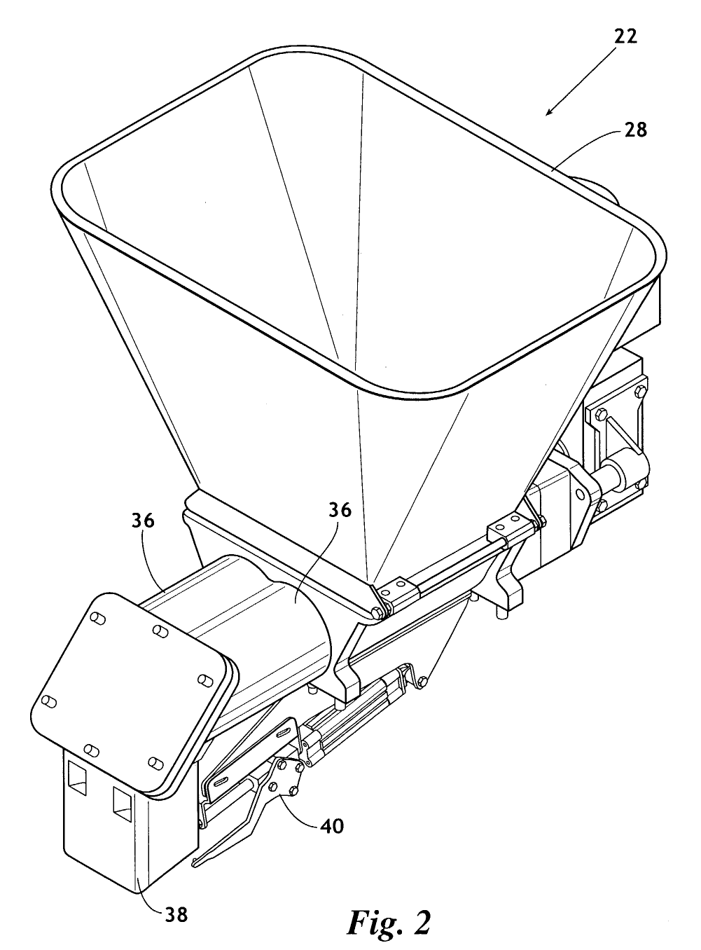

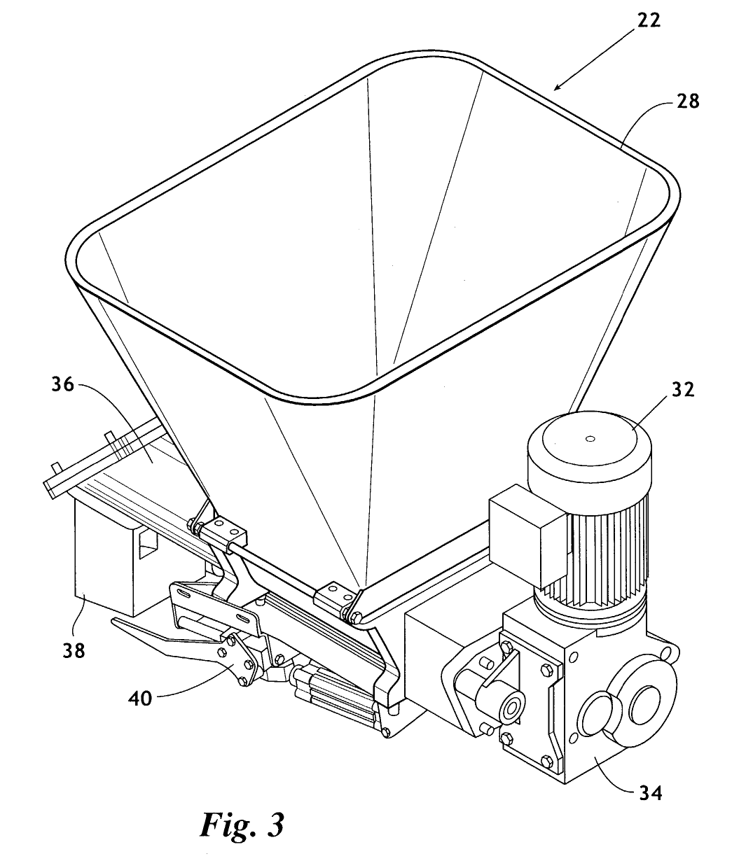

Generally speaking, screw extruders are well known in the art. Such devices typically include: a hopper through which an extrudable food product is fed; a motor driven auger, or screw, positioned below the hopper which compresses and drives the product towards the output of the extruder; and an extrusion die at the output of the extruder which imparts a desired cross-sectional shape to the product stream. Referring to FIGS. 2 and 3, extruder 22 is fairly typical of such screw extruders. Preferably, extruder 22 includes: funnel-shaped hopper 28; a motor 32 and gearbox 34 for rotationally driven a pair of augers (not shown); a pair of extruder tubes 36 through which the dough is driven by the augers; an extrusion die 38 which extrudes the flow of dough into a desired form; and knife subassembly 40, preferably a guillotine-type cutter, slices the flow of compressed dough into individual dough pucks 30 (FIG. 4A) as the dough exits the extrusion die. In the preferred embodiment, the interior surfaces of extrusion tubes 36 are polished to reduce dough friction.

Preferably motor 32 is driven by a servo controller, or similar closed-loop controller such that the speed of motor 32 can be controlled to maintain dough pucks of consistent thickness or consistent weight. As will become apparent to those skilled in the art from the discussion hereinbelow, knife 40 is typically operated at a rate which achieves a desired spacing between dough pucks in light of the conveyor speed of downstream assemblies. Motor 32 may then be controlled to maintain consistent size or weight between individual dough pucks 30. Alternatively, motor 32 could be set to operate at a consistent speed and knife 40 controlled to produce consistent pucks. Unfortunately, in such an arrangement the throughput of the system would suffer somewhat.

Turning again to FIG. 4A, as dough pucks 30 are produced by extruder 22, pucks 30 are deposited onto weight check conveyor 42. Weight check conveyor 42 measures either the weight or height of pucks 30 as they are produced and provides feedback to the controller of motor 32 to increase or decrease the speed of the augers as necessary to ensure pucks of consistent weight or size. The weight check conveyor 42 delivers dough pucks 30 to the infeed portion 44 of the continuous pressing apparatus 24.

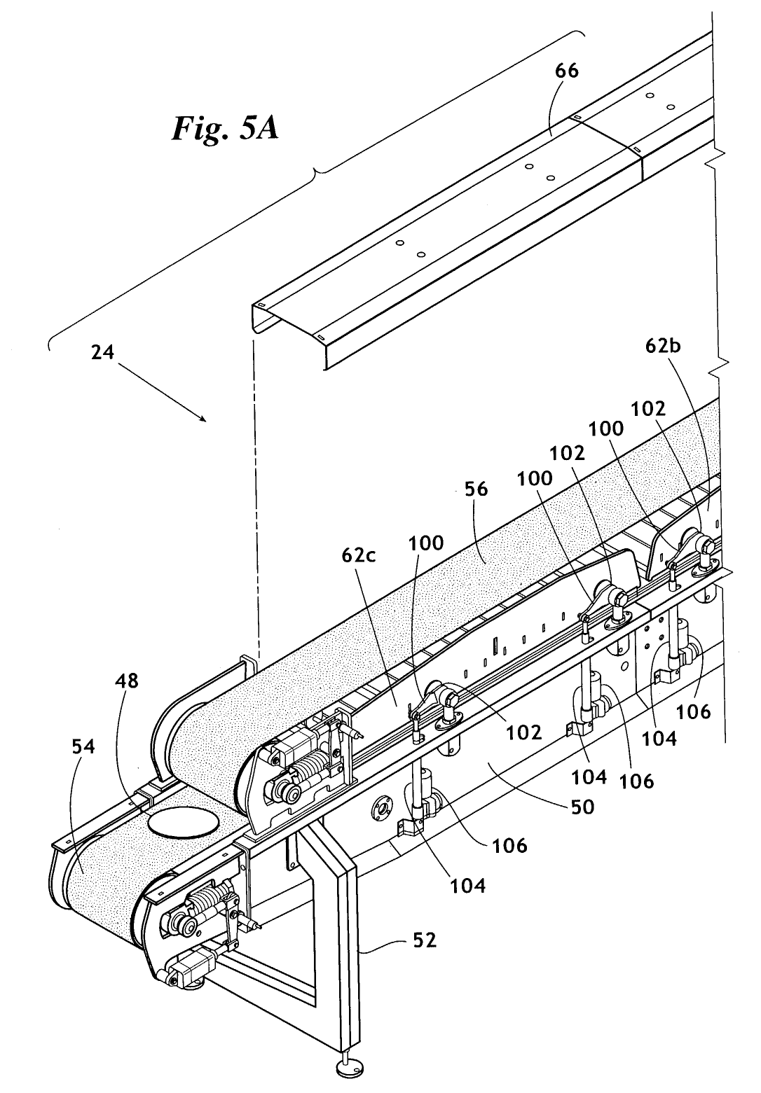

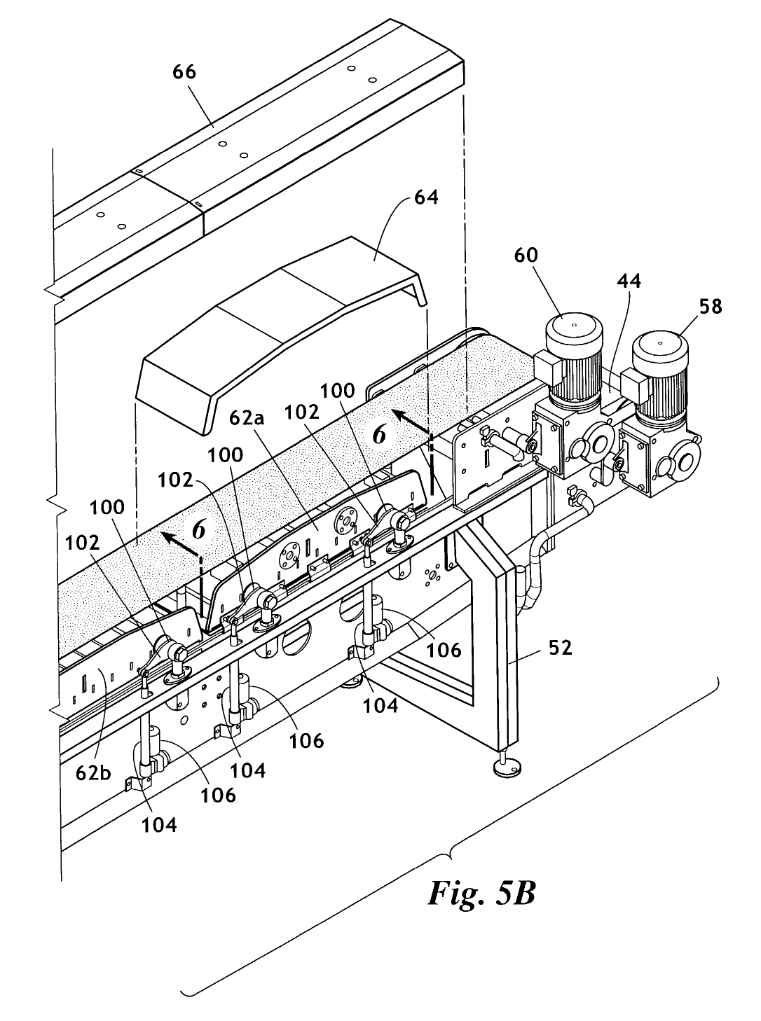

Referring to FIGS. 5A and 5B, preferably pressing apparatus 24 comprises: a frame 50 having a plurality of supporting legs 52; a lower conveyor belt 54; a counter-rotating upper conveyor belt 56 which moves at the same speed as lower belt 54; a pair of motors and gearboxes 58 and 60 for driving the lower conveyor belt 54 and upper conveyor belt 56, respectively; a plurality of pressure plate assemblies 62a-c; a plurality of pressure plate covers 64 (only one shown) each cover 64 sandwiched between the top of its corresponding pressure plate assembly and the upper run of upper belt 56; and conveyor cover 66.

As dough pucks 30 reach the infeed portion 44 of lower belt 54, the pucks are drawn into pressing apparatus 24 where pucks 30 become sandwiched between the upper run of lower belt 54 and the lower run of upper belt 56 as they are conveyed through press 24. As pucks 30 progress through the system, sandwiched between belts 54 and 56, they are carried successively through the series of pressure plate assemblies 62a-c which gradually press and move the dough outward to provide the desired size and shape of the finished tortilla product. In a particularly preferred embodiment, each conveyor belt is a Teflon® coated, stainless steel belt.

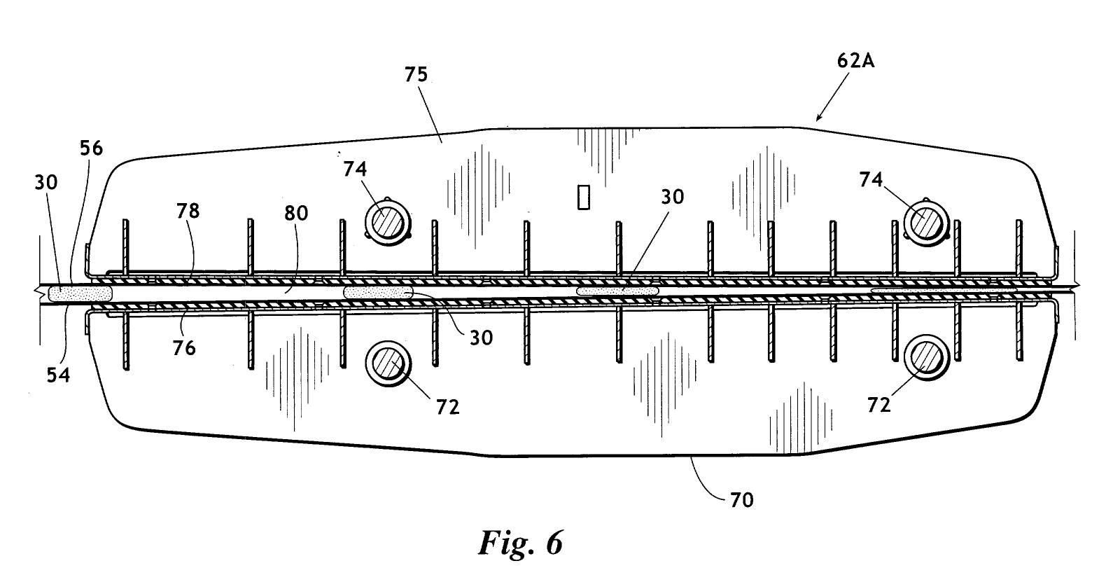

With further reference to FIG. 6, wherein is shown a section view of pressure plate assembly 62a. Assembly 62a is typical of the other pressure plate assemblies 62b-c. Preferably pressure plate assembly 62a includes: a lower platen 70 supported by a pair of axially extending rods 72; an upper platen 75, likewise supported by a pair of axles 74; a lower slide 78 secured to the upper surface of lower platen 70 for contact with belt 54; and a top slide 80 secured to the lower surface of upper platen 78 for contact with belt 56. Preferably upper platen 75 and lower platen 70 are held in a fixed relationship such that a gap 82 of ever decreasing thickness is created therebetween. As will be apparent to those skilled in the art, since conveyor belts 54 and 56 are counter-rotating, both belts are moving in the same linear direction, preferably at the same linear speed, as they pass through gap 82. Thus, as a dough puck 30 is drawn through pressure plate assembly 62a by upper belt 56 and lower belt 54 (shown moving left to right in FIG. 6), dough puck 30 will be pressed into an ever thinner form. Platens 70 and 75 may optionally be heated.

Continuing with FIGS. 5A and 5B, the upper platens 75 of pressure plate assemblies 62a-c are attached to frame 50 through a series of eccentric lobes 100 connected to axles 74. Each eccentric lobe 100 includes a control arm 102 and link 104 which is, in turn, connected to a servo 106. Servos 106 may be controlled to adjust the size and taper of gap 82 (FIG. 6) to control the amount of “press” applied to the dough puck during each pressing stage and to control the thickness of the final product. In fact, if a vision system, or other measuring system, is used at outfeed 48, pressure plate assemblies 62a-c may be continuously adjusted to produce tortillas of a consistent, precise diameter at outfeed 48.

As will be apparent to those skilled in the art, the ultimate shape of the tortilla will be dependent on both the shape of the dough puck, as determined by extrusion die 38 (FIG. 2) and the motion of the conveyors 54 and 56 which tend to move dough more in a longitudinal direction than across the conveyors. By controlling the aspect ratio of the dough pucks through the selection of die 38, tortillas of virtually any shape may be produced by the inventive apparatus. To obtain round tortillas, dough puck 30 would be given a generally elliptical shape.

Referring again to FIGS. 4A-4C, as individual tortillas exit press 24 at outfeed portion 48, they are delivered to the infeed portion of oven 26. Construction of oven 26 is very similar to that of press 24. Oven 26 preferably includes: a frame 110 supported by a plurality of legs 112; a lower conveyor belt 114; a counter-rotating upper conveyor belt 116 which moves at the same speed as lower belt 114; a pair of motors and gearboxes 118 and 120 for driving the lower conveyor belt 114 and upper conveyor belt 116, respectively; a plurality of heated platen assemblies 122a-c; a plurality of platen covers 124, each cover 124 sandwiched between the top of its corresponding platen assembly and the upper run of upper belt 116.

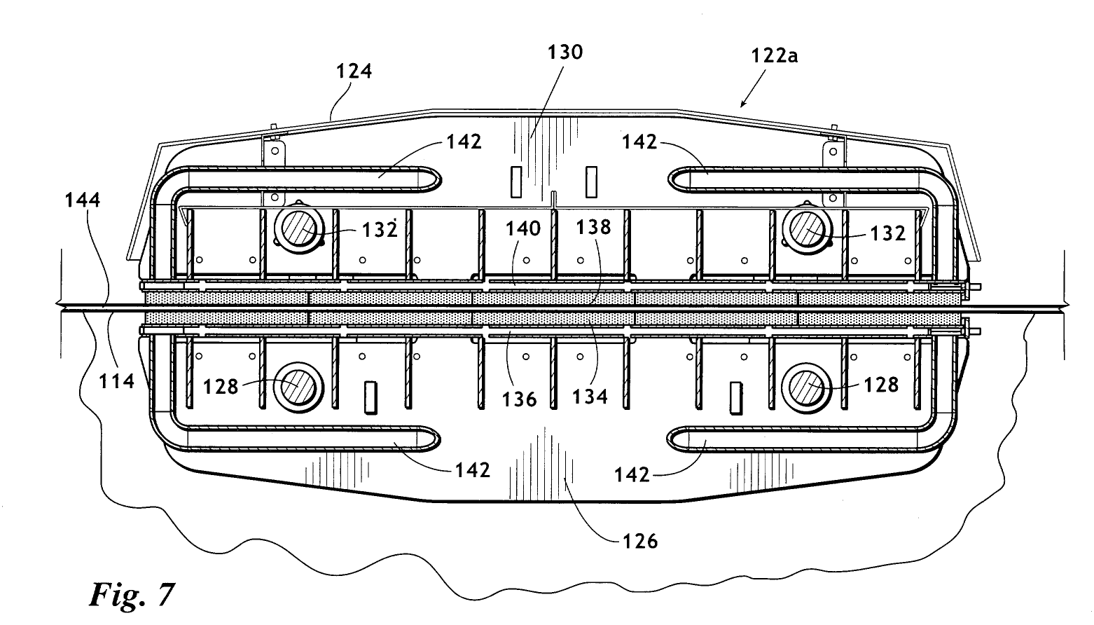

Referring to FIG. 7, heater platen subassembly 122a is typical of its sister heater platen assemblies 122b and 122c. Platen assembly 122a comprises: a lower heater platen 126 supported by axles 128; an upper heater platen 130 supported by axles 132; a bottom slide 134 secured to lower platen 126 for contact with lower belt 114; heating medium 136 sandwiched between slide 134 and platen 126; a top slide 138 secured to upper platen 130 for contact with upper belt 116; and heating medium 140 sandwiched between top slide 138 and upper platen 130. Heating elements 142 are used to heat platens 126 and 130. Formed tortilla from press 24 are carried through gap 144 formed between platens 126 and 130 while sandwiched between the upper belt 116 and lower belt 114.

With further reference to FIG. 4C, after successively passing through the series of heated platens 122a-c, cooked tortillas are delivered to outfeed area 108 of oven 26. In a manner similar to that employed in press 24, upper heater platens 130 can be adjusted vertically through eccentric lobes 146 and servos 148 to control gap 144. As will be apparent to those skilled in the art, gap 144 could be controlled in a tapered fashion, as in press 24, to perform some measure of pressing during one or more cooking steps.

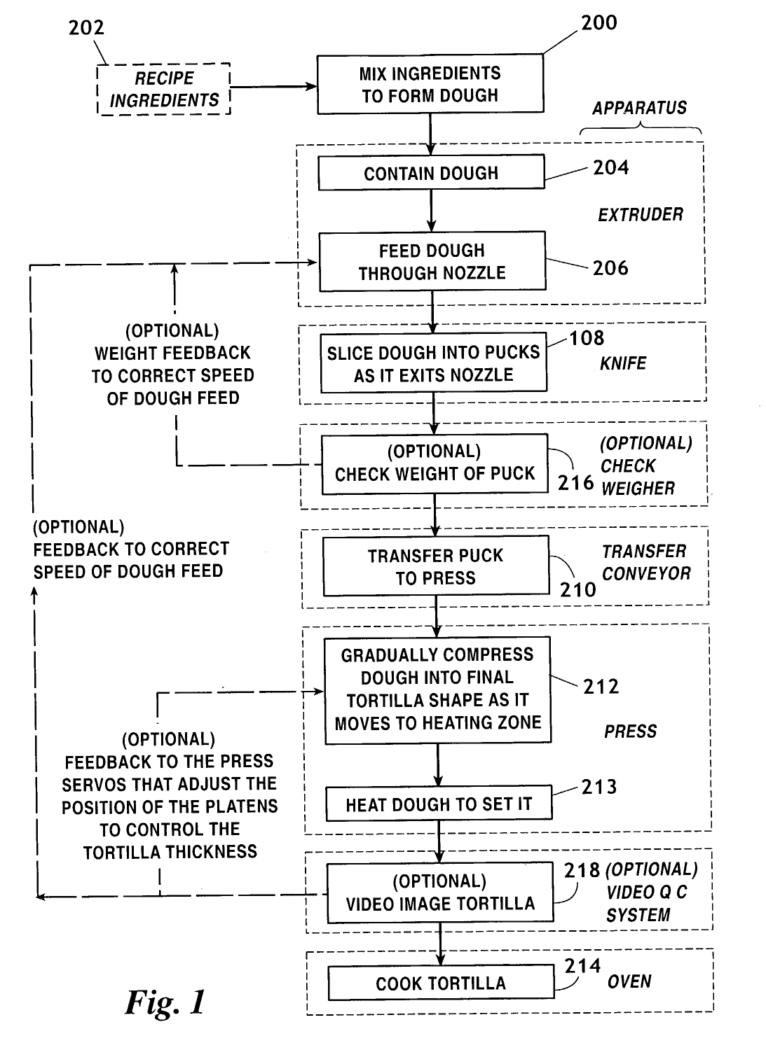

The process of making a tortilla using the inventive system of described in the flow diagram of FIG. 1. While not a performed within the apparatus of the present invention, tortilla dough must be prepared at step 200 according to a recipe or process as indicated at 202. Once made, at step 204 tortilla dough is fed into the extruder, for example through a hopper, where it is compressed and forced through an extrusion nozzle at 206. As dough exits the nozzle at step 208, the extrusion is sliced into a series of dough pucks. At 210, pucks are transferred to the pressing apparatus and, in a continuous operation, gradually compressed into a final tortilla shape at step 212. As tortillas pass from the press, they move to the oven wherein cooking takes place at 214. The pressing apparatus may be heated, as indicated at step 213 to impart sufficient heat to the tortillas to improve their ability to transfer from the pressing operation to the cooking operation.

Optionally, as dough pucks are created pucks can be weighed, or measured through a machine vision system, to determine the weight or thickness of the pucks at step 216. Puck-to-puck variations can be virtually eliminated by using this information to control the speed of the extruder at step 206. In another optional step at 218, a machine vision system, or video system, can be used to measure the size of the pressed tortilla just prior to cooking. This information can be used to adjust the press platens so that the pressing operations at 212 produce tortillas of precise dimensions. The information gathered at 218 can likewise be used to control the speed of the extruder to obtain consistent product.

As will be apparent to those skilled in the art, numerous modifications could be made to the preferred embodiment without deviating from the scope or spirit of the present invention. For example, while a screw extruder has been employed in conjunction with the preferred embodiment, virtually any type of extruder will suffice, the important feature simply being the production of consistent dough pucks. Similarly, in the preferred embodiment, vertical adjustment of the various platen assemblies is achieved using eccentric lobes. While such vertical adjustment plays an important role in the versatility of the present invention, the means of achieving such vertical adjustment is unimportant. Thus, linear actuators, hydraulic or pneumatic cylinders, or various cam arrangements could be employed to adjust the platens up or down without deviating from the scope or spirit of the present invention.

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention as defined by the appended claims.

What is claimed is:

1. A tortilla press assembly comprising:
a frame;
an infeed portion for receiving dough pucks;
a first platen having a first pressing surface, said first platen secured to said frame;
a second platen having a second pressing surface, said second platen secured to said frame such that a gap is formed between said first pressing surface and said second pressing surface;
a first conveyor having a first conveyor belt which passes through said gap in a first direction at a first linear speed;
a second conveyor having a second conveyor belt which passes through said gap in said first direction at a second linear speed, said second linear speed being substantially the same as said first linear speed,
wherein the dough pucks received at said infeed portion are sandwiched between said first and second conveyor belts and carried through said gap to press each dough puck into a tortilla product.

2. The tortilla press of claim 1 wherein said first platen is secured to said frame in an adjustable manner such that said gap between said first pressing surface and said second pressing surface may be adjusted.

3. The tortilla press of claim 2 further comprising a servo for adjusting said gap.

4. The tortilla press of claim 3 wherein said servo is controlled to press the dough pucks into tortillas of a consistent diameter.

5. A system for converting tortilla dough to a tortilla product comprising:
an extruder comprising:
an input for receiving tortilla dough;
a nozzle through which said tortilla dough is compressed; and
an actuated knife controlled to slice the compressed dough into dough pucks; and
a press assembly comprising:
a press frame;
a press infeed portion;
a first platen having a first pressing surface, said first platen secured to said press frame;
a second platen having a second pressing surface, said second platen secured to said press frame such that a first gap is formed between said first pressing surface and said second pressing surface;
a first conveyor having a first conveyor belt which passes through said first gap in a first direction at a first linear speed; and
a second conveyor having a second conveyor belt which passes through said first gap in said first direction at a second linear speed, said second linear speed being substantially the same as said first linear speed,
wherein dough pucks from said extruder are received at said press infeed portion, sandwiched between said first and second conveyor belts and carried through said first gap to press each dough puck into a tortilla product.

6. The system for converting tortilla dough of claim 5 further comprising an oven, said oven comprising:
an oven frame;
an oven infeed portion;
a first heater platen having a first cooking surface, said first heater platen secured to said frame;
a second heater platen having a second cooking surface, said second heater platen secured to said frame such that a second gap is formed between said first cooking surface and said second cooking surface;
a third conveyor having a third conveyor belt which passes through said second gap in a second direction at a third linear speed; and
a fourth conveyor having a fourth conveyor belt which passes through said second gap in said second direction at a fourth linear speed, said fourth linear speed being substantially the same as said third linear speed,
wherein tortilla product from said press assembly is received at said infeed portion, sandwiched between said third and fourth conveyor belts and carried through said second gap to cook the tortilla port duct.

7. The system for converting tortilla dough of claim 5 wherein said first platen is secured to said press frame in an adjustable manner such that said first gap between said first pressing surface and said second pressing surface is adjustable.

8. The system for converting tortilla dough of claim 7 further comprising a servo for adjusting said gap.

9. The system for converting tortilla dough of claim 6 wherein said first heater platen is secured to said oven frame in an adjustable manner such that said second gap between said first cooking surface and said second cooking surface is adjustable.

10. The system for converting tortilla dough of claim 9 further comprising a servo for adjusting said second gap.

11. A tortilla press assembly comprising:
a frame;
an infeed portion for receiving dough pucks;
a plurality of pressure plate assemblies, each pressure plate assembly comprising:
a first platen having a first pressing surface, said first platen secured to said frame; and
a second platen having a second pressing surface, said second platen secured to said frame such that a gap is formed between said first pressing surface and said second pressing surface;
a first conveyor having a first conveyor belt which passes through all of said gaps formed in said plurality of pressure plate assemblies in a first direction at a first linear speed;
a second conveyor having a second conveyor belt which passes through all of said gaps formed in said plurality of pressure plate assemblies in said first direction at a second linear speed, said second linear speed being substantially the same as said first linear speed,
wherein a dough puck received at said infeed portion are sandwiched between said first and second conveyor belts and carried successively through each of said gaps to press the dough pucks into a tortilla product.

12. The tortilla press of claim 11 wherein said first platen of each pressure plate assembly of said plurality of pressure plate assemblies is secured to said press frame in an adjustable manner such that said the gap between said first pressing surface and said second pressing surface of each pressure plate assembly is adjustable.

13. The system for converting tortilla dough of claim 12 further comprising a plurality of servos, each pressure plate assembly having at least one servo associated therewith for adjusting said gap associated with said pressure plate assembly.

14. A tortilla oven comprising:
a frame;
an infeed portion for receiving pressed tortilla product;
a plurality of heated platen assemblies, each heated platen assembly comprising:
a first platen having a first cooking surface, said first platen secured to said frame;
a second platen having a second cooking surface, said second platen secured to said frame such that a gap is formed between said first cooking surface and said second cooking surface; and
a heater element for heating said first and second platens;
a first conveyor having a first conveyor belt which passes through all of said gaps formed in said plurality of pressure plate assemblies in a first direction at a first linear speed;
a second conveyor having a second conveyor belt which passes through all of said gaps formed in said plurality of heated platen assemblies in said first direction at a second linear speed, said second linear speed being substantially the same as said first linear speed,
wherein tortilla product received at said infeed portion is sandwiched between said first and second conveyor belts and carried successively through each of said gaps to cook the tortilla product.

15. The tortilla oven of claim 14 wherein said first heated platen of each heated platen assembly of said plurality of heated platen assemblies is secured to said press frame in an adjustable manner such that said the gap between said first cooking surface and said second cooking surface of each heated platen assembly is adjustable.

16. The tortilla oven of claim 15 further comprising a plurality of servos, each heated platen assembly having at least one servo associated therewith for adjusting said gap associated with said heated platen assembly.

17. A method for pressing tortillas in a continuous operation including the steps of:
(a) receiving a dough puck between a first conveyor belt and a second conveyor belt, said first conveyor conveying said dough puck in a first direction at a first speed and second conveyors conveying said dough puck in said second direction at a second speed, said second speed being substantially the same as said first speed;
(b) while sandwiched between said first conveyor and said second conveyor, carrying said dough puck through a gap of decreasing width such that said dough puck is gradually pressed into a flat, round tortilla;
(c) delivering the flat, round tortilla to an outfeed portion of said first conveyor.

18. A method for making tortillas including the steps of:
(a) feeding dough into the hopper of an extruder;
(b) extruding said dough into a continuous flow of consistent cross-sectional shape;
(c) periodically slicing said continuous flow to form a series of dough pucks;
(d) performing the method of claim 17 to press each of said dough, pucks into a tortilla; and
(e) cooking each tortilla in an oven.

19. The method for making tortillas of claim 18 wherein the speed of the extruder is controllable and including the additional steps of:
(c)(i) periodically slicing said continuous flow to form a series of dough pucks;
(c)(ii) measuring the weight of each dough puck; and
(c)(iii) comparing the weight of each dough puck to a predetermined value and increasing or decreasing the speed of said extruder in response to the comparison such that said series of dough pucks are of a substantially constant weight.

20. The method for making tortillas of claim 18 wherein said gap is adjustable and including the further steps of:
(d)(i) performing the method of claim 17 to press each of said dough pucks into a tortilla;
(d)(ii) measuring the diameter of each tortilla; and
(d)(iii) comparing said diameter of each tortilla to a predetermined value and increasing or decreasing the gap in response to the comparison such that each tortilla is of a substantially consistent diameter.
